(19) United States
(12) Patent Application Publication
(10) Pub. No.: US 2010/0291516 A1
(43) Pub. Date: Nov. 18, 2010

(54) BRAIN-TRAINING PRESS BLOCK

(76) Inventor: Ying-Jen CHEN, Taoyuan (TW)

Correspondence Address: Yen Jung Sung, 21-80 38 St, #C8, Astoria, NY, 11105, US

(21) Appl. No.: 12/467,292

(22) Filed: May 17, 2009

(51) Int. Cl. G09B 19/02

(52) U.S. Cl. 434/188; 434/403

(57) ABSTRACT

A brain-training press block includes a casing, which has a partition panel suspending in an accommodation chamber thereof, through holes cut through the partition panel and protruding portions respectively perpendicularly protruded from two opposite sides of the partition panel, and two buttons respectively inserted into the accommodation chamber at two opposite sides relative to the partition panel, each button having a flat base, a plurality of push blocks respectively perpendicularly protruded from one side corresponding to the through holes of the partition panel and a plurality of through holes corresponding to the protruding portions of the casing. A user can alternatively press the two buttons to see a surface change of the flat bas of the button being pressed.

### BACKGROUND OF THE INVENTION

1. Field of the Invention

The present invention relates to brain-training devices and more particularly, to a brain-training press block that is repeatedly pressable and shows a surface variation when pressed.

2. Description of the Related Art

Playing brain-training games help coordinate the brain, stabilize emotional stability, and improve brain power, concentration power and learning ability. Playing brain-training games is an important training in life. Arithmetic game is one of the most favorite brain-training games among people for the advantages of being easy to perform with simply a pen and a piece of paper without any limitation on number of persons. However, arithmetic game is not fully environmentally friendly because it consumes paper.

### SUMMARY OF THE INVENTION

The present invention has been accomplished under the circumstances in view. It is one object of the present invention to provide a brain-training press block, which is environmentally friendly design and has the advantage of ease of use.

To achieve this and other objects of the present invention, a brain-training press block comprises a casing, which has a partition panel suspending in an accommodation chamber thereof, through holes cut through the partition panel and protruding portions respectively perpendicularly protruded from two opposite sides of the partition panel, and two buttons respectively inserted into the accommodation chamber at two opposite sides relative to the partition panel, each button having a flat base, a plurality of push blocks respectively perpendicularly protruded from one side corresponding to the through holes of the partition panel and a plurality of through holes corresponding to the protruding portions of the casing. A user can alternatively press the two buttons to see a surface change of the flat bas of the button being pressed.

### BRIEF DESCRIPTION OF THE DRAWINGS

FIG. 1 is an elevational view of a brain-training press block in accordance with the present invention.

FIG. 2 is an exploded, partially cutaway of the brain-training press block in accordance with the present invention.

FIG. 3 corresponds to FIG. 1, showing one button pressed.

FIG. 4 is an enlarged view in sectional elevation of FIG. 3.

FIG. 5 shows a set of brain-training press blocks arranged in a case according to the present invention.

### DETAILED DESCRIPTION OF THE PREFERRED EMBODIMENT

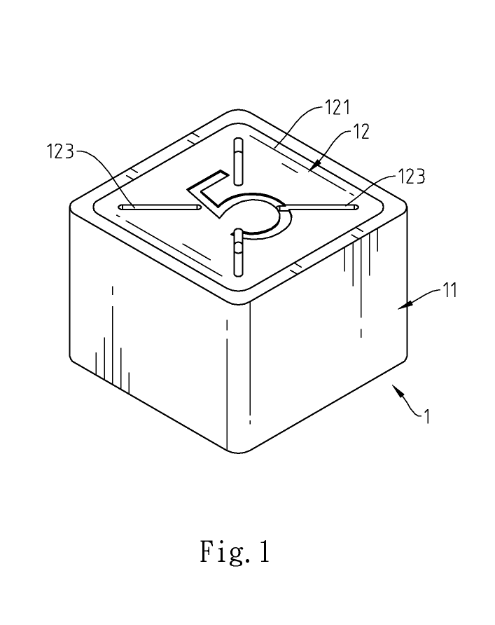

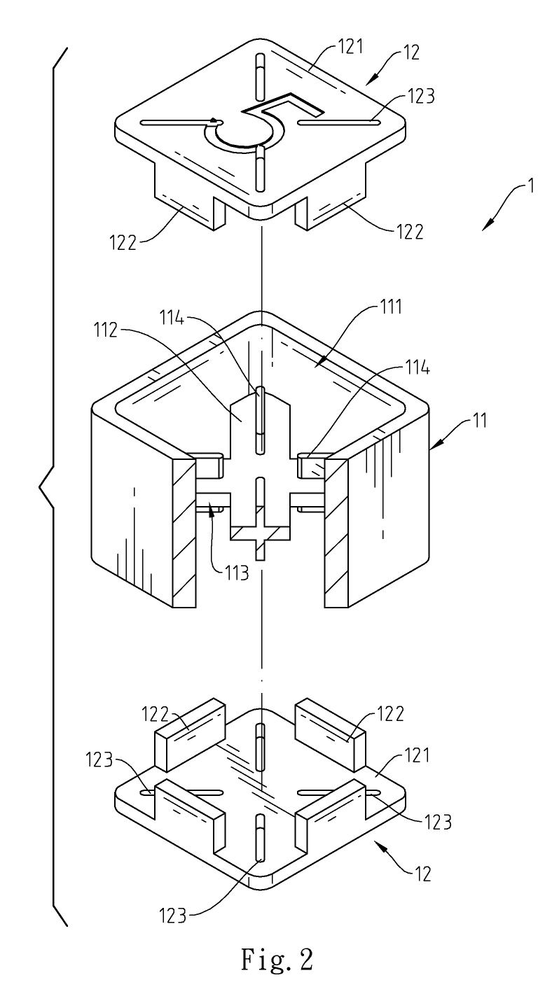

Referring to FIGS. 1 and 2, a brain-training press block 1 in accordance with the present invention is shown comprising a casing 11 and two buttons 12.

The casing 11 is a single piece of hollow shell, having an accommodation chamber 111 extending through top and bottom sides thereof, a partition panel 112 suspending in the accommodation chamber 111 on the middle and connected to the peripheral wall of the casing 11, a plurality of through holes 113 cut through the partition panel 112 and respectively disposed adjacent to the peripheral wall of the casing 11, and a plurality of protruding portions 114 respectively perpendicularly protruded from the top and bottom sides of the partition panel 112. Further, the casing 11 is two-folds higher than the height of each button 12.

The two buttons 12 are configured to fit the accommodation chamber 111, each having a flat base 121, a plurality of push blocks 122 respectively perpendicularly protruded from one side of the flat base 121 around the border and a plurality of through holes 123 corresponding to the protruding portions 114 of the casing 11. The two buttons 12 are respectively inserted into the accommodation chamber 111 at two sides of the partition panel 112 with the respective protruding portions 114 aimed at the partition panel 112.

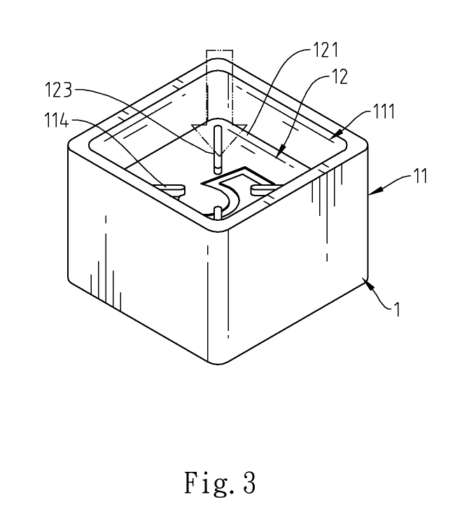

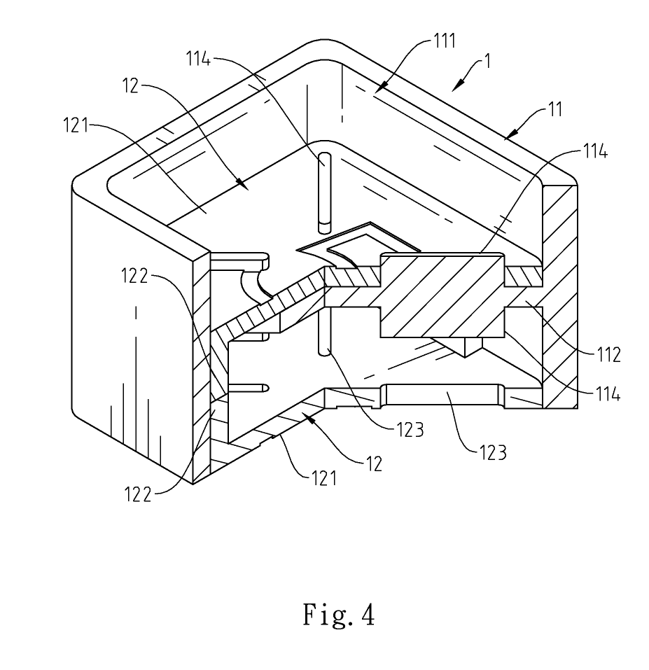

Referring to FIGS. 3 and 4, when playing the brain-training block 1, a user can press the flat base 121 of one button 12 to move this button 12 toward the inside of the accommodation chamber 111, i.e., toward the other button 12. During movement of the respective button 12, the through holes 123 of the respective button 12 are forced onto the protruding portions 114 of the casing 11, and at the same time the surface of the flat base 121 of the respective button 12 varies with movement of the respective button 12, and the user can see the change of the surface of the flat base 121.

When the user turned the brain-training press block upside-down and pressed the other button 12 toward the previously pressed first button 12, the push blocks 122 of this second button 12 are forced against the push blocks 122 of the previously pressed first button 12 to move the previously pressed first button 12 back to its former position, so that the through holes 123 of the previously pressed first button 12 are disengaged from the protruding portions 114 of the casing 11, and the through holes 123 of the second button 12 are respectively forced onto the protruding portions 114 of the casing 11, causing the surface of the flat base 121 of the second button 12 to vary with movement of the second button 12. Thus, a user can press the two buttons 12 of the brain-training press block alternatively repeatedly.

Further, the protruding portions 114 of the casing 11 can be colored with a particular color, or the casing 11 and the buttons 12 can be made in different colors. Thus, when the protruding portions 114 of the casing 11 pass through the through holes 123 of the respective button 12, a significant surface change of the flat base 121 of the button 12 being pressed can be seen clearly.

Further, the flat base 121 of the button 12 can be marked with a pattern or number that represents the identity of the respective button 12.

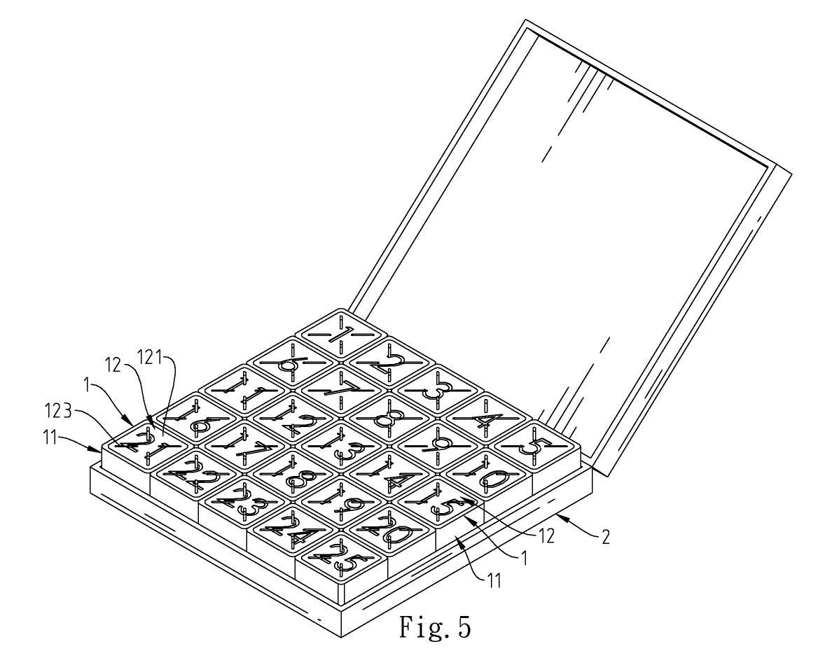

Referring to FIG. 5, a number of brain-training press blocks can be arranged in a set and received in a case 2 that can be closed and turned upside down and then opened again for enabling the user to press the button at the second side of each of the brain-training press blocks.

A prototype of brain-training press block has been constructed with the features of FIGS. 1-5. The brain-training press block functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A brain-training press block, comprising:
a casing, said casing having an accommodation chamber extending through top and bottom sides thereof, a partition panel suspending in said accommodation chamber and connected to the peripheral of said casing, a plurality of through holes cut through said partition panel and respectively disposed adjacent to the periphery of said casing, and at least one protruding portion respectively perpendicularly protruded from each of two opposite sides of said partition panel; and
two buttons respectively inserted into said accommodation chamber at two opposite sides relative to said partition panel, each said button having a flat base, a plurality of push blocks respectively perpendicularly protruded from one side of said flat base around the border thereof and at least one through hole corresponding to the protruding portions of said casing.

2. The brain-training press block as claimed in claim 1, wherein said casing has a plurality of protruding portions respectively perpendicularly protruded from each of two opposite sides of said partition panel each said button has multiple through holes for the passing of the protruding portions at one of the two opposite sides of said partition panel.

3. The brain-training press block as claimed in claim 1, wherein said casing and buttons are made in integrity.
